(19) United States
(12) Patent Application Publication
(10) Pub. No.: US 2018/0348117 A1
(43) Pub. Date: Dec. 6, 2018

(54) GAS ANALYZERS WITH A MOLECULAR SIEVE

(71) Applicant: Campbell Scientific, Inc., Logan, UT (US)

(72) Inventors: Ivan G. Bogoev, Hyde Park, UT (US); Steven D. Sargent, Logan, UT (US); Rex P. Burgon, Logan, UT (US)

(21) Appl. No.: 15/994,678

(22) Filed: May 31, 2018

Related U.S. Application Data
(60) Provisional application No. 62/512,968, filed on May 31, 2017.

(51) Int. Cl. G01N 21/15

(52) U.S. Cl. CPC G01N 21/15

(57) ABSTRACT

Embodiments of the invention relate to a gas analyzer or other device and to a gas analyzer that is configured with a purger that is configured to remove certain gasses from an interior of the gas analyzer. A molecular sieve is an example of a purger or of a purging structure that may be disposed within the housing of the gas analyzer. The purger may be positioned within or inside of the housing such that the unwanted gasses are absorbed or adsorbed through diffusion. The purger is replaceable.

### CROSS-REFERENCE TO RELATED APPLICATIONS

The present application claims priority to U.S. Patent Application No. 62/512,968, filed May 31, 2017, which is hereby incorporated by reference in its entirety.

### BACKGROUND OF THE INVENTION

### 1. The Field of the Invention

Embodiments of the invention relate to a gas analyzer. More particularly, embodiments of the invention relate to purging gases such as water vapor and carbon dioxide from the gas analyzer or, more specifically, from an interior of the gas analyzer.

### 2. The Relevant Technology

Gas analyzers typically use a light source to project a beam of light through a gas sample. The beam of light is captured by a detector after passing through the gas sample and then analyzed. The captured beam of light is analyzed to measure the amount of light absorbed by the gas sample. In many instances, gas analyzers generally use a series of filters, including a sample filter and reference filters, disposed between the light source and the detector in order to determine the degree to which certain wavelengths of light transmitted through the filters are absorbed by the gas sample.

One difficulty associated with gas analyzers relates to the need to purge gases such as carbon dioxide and water vapor from within the gas analyzers. This has been accomplished using, as dessicants, magnesium perchlorate or sodium/potassium hydroxide. However, these types of materials are hazardous or corrosive and may have a negative impact on the environment. What is needed are systems, apparatus, and/or methods for purging gasses such as carbon dioxide and water vapor from gas analyzers in a manner that is not hazardous or corrosive and that reduces the impact of the gas analyzer on the environment.

### BRIEF DESCRIPTION OF THE DRAWINGS

To further clarify at least some of the advantages and features of embodiments of the present invention, a more particular description of embodiments of the invention will be rendered by reference to specific embodiments thereof which are illustrated in the appended drawings. It is appreciated that these drawings depict only typical embodiments of the invention and are therefore not to be considered limiting of its scope. Embodiments of the invention will be described and explained with additional specificity and detail through the use of the accompanying drawings in which:

FIG. 1 illustrates a perspective view of an open path gas analyzer that includes a purger configured to purge an interior of the gas analyzer;

FIG. 2 illustrates a cross-sectional view of the gas analyzer and illustrates examples of open spaces in the interior that may be purged by a purger;

FIG. 3A illustrates an example of a closed path gas analyzer that includes a purger;

FIG. 3B illustrates another example of a closed path gas analyzer;

FIG. 3C illustrates an example of a purger includes in a component of a closed path gas analyzer; and

FIG. 3D illustrates an example of a purger included in another component of the closed path gas analyzer.

### DETAILED DESCRIPTION OF THE EMBODIMENTS

Embodiments of the invention relate to a gas analyzer. Embodiments of the invention further relate to a gas analyzer that is configured with a purger that is configured to remove certain gasses from an interior of the gas analyzer. A molecular sieve is an example of a purger or of a purging structure that may be disposed within the housing of the gas analyzer. The purger may be positioned within or inside of the housing such that the unwanted gasses are adsorbed or absorbed through diffusion. In one example, the gasses are absorbed or adsorbed over time as the gasses diffuse within the interior of the gas analyzer. In one example, the gas analyzer may be left alone or idle until the gasses are sufficiently purged. In some examples, the gas analyzer may include multiple purgers disposed at different locations inside the gas analyzer. The purgers may be replaceable and the analyzer may be able to provide a notification indicating that the purger requires replacement. The purger could be replaced, however, according to a schedule or in accordance with maintenance.

In addition, the interior of the gas analyzer and the components housed inside the gas analyzer may be arranged such that the rate of diffusion of gasses inside the interior are not limited or are not overly limited. For example, purgers may not be placed on or in housing sections with small passages or blind holes in the interior of the gas analyzer. The interior surfaces, or portions thereof may be lined with a purger such as a molecular sieve. In one example, the amount of purger or scrubbing component may be based on a volume of the interior, the material of the housing, the components housed inside the housing, and the like or any combination thereof.

The gas analyzers may be closed-path type gas analyzers or open-path type gas analyzers and may be symmetrical. In addition, some gas analyzers can be combined or configured with other sensors or measurement devices. For example, a gas sensor may be used in association with or integrated with a sonic anemometer, barometer, or other sensor.

Embodiments of a gas analyzer can measure, by way of example only, carbon dioxide, water vapor, methane, nitrous oxide, isotopologs of carbon dioxide or the like or combination thereof. Embodiments of a gas analyzer may also be configured to measure flux including eddy covariance flux, air temperature, barometric pressures, three-dimensional wind speed, and the like. The gas analyzer, for example, can measure and calculate turbulent fluxes within the atmosphere. Flux measurements can be used to estimate and/or determine water, carbon dioxide, and other gases. The data generated by gas analyzers can be used in climatology, and other disciplines.

During operation of the gas analyzer, certain gasses may begin to accumulate in an interior of or within the housing of the gas analyzer. Stated differently, the composition of gasses in an interior of the housing may change over time. This may impact the measurements performed by the gas analyzer because these gases may impact the light used in determining the quantities of gasses in an air sample. The purger is configured to absorb or adsorb these gasses. This ensures that measurements performed by the gas analyzer are more accurate and are not influenced by gasses that are not part of the sample gas (e.g., an air sample).

An open-path gas analyzer typically refers to an analyzer where the sample path is exposed while a sample path of a closed-path gas analyzer is not exposed.

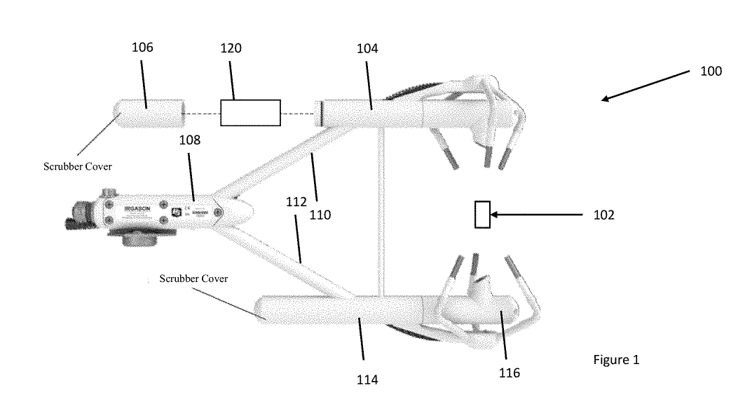

FIG. 1 illustrates an example of an open path analyzer 100. FIG. 1 illustrates that the analyzer 100 includes a housing that may include multiple housings or housing portions. The housing includes housings 104, 106, 108, 110, 112, 114, and 116. In this example, various components may be disposed or arranged in the housing portions. When connected, the housing of the analyzer 100 or portions thereof may be sealed (e.g., using O-rings). More specifically, the various housings can be welded together, connected with a seal, made in an integrated manner or the like or combination thereof. Some connections may be permanently sealed while other connections may be sealed using an O ring for example. FIG. 1 illustrates that the housing 106 connects to the housing 104 using a seal. This allows a component such as a purger 120 (discussed below) to be replaceable. Other housing junctions may be permanent in nature. The housing of the analyzer 100 may be configured such that access to components disposed in the interior of the housing can be accessed, repaired, replaced, or the like.

The housings 104 and 116 may contain optical components. For example, optical components within the housing 116 may emit light that passes through a sensing path 102 and that is received by optical components inside the housing 104. An analysis may be performed on the received light that has passed through an air sample (e.g., the air in the air path 102). Depending on the composition of the air sample, different molecules of different substances or gasses will absorb different frequencies of light. The received light can thus be analyzed to determine the various quantities of different gasses in the air sample based on how the various frequencies of light were absorbed.

In one example, the optical components and the processing component are an example of a sensing system that is configured to measure or determine the quantities or types of gasses included or associated with an air sample.

The housings 110 and 112 connect the sides of the analyzer 100 with a housing 108. The housing 108 may contain, for example, processing components (e.g., a processor, controller, circuits, memory, etc.). The housings 110 and 112 may provide room for cabling to connect the processing components with the optical components contained in the housings 104 and 116. The housing 106 and/or 114 may contain a purger 120. The interior of the analyzer 100 is the open and may be connected.

The purger 120 may be, in one example, a molecular sieve. The molecular sieve may include a material with pores that are similar in size to various molecules. A 13X molecular sieve, for example, may provide dessication and purification functions with respect to the interior of the analyzer 100. For example, H₂O and CO₂ may be absorbed or adsorbed and thus removed from an interior of the housing of the gas analyzer 100. The housing of the analyzer 100 may include open portions throughout the interior. By removing various gasses, the measurements taken by the analyzer 100 reflect the concentration or quantities of the gasses in the air sample and not of the gasses present inside the analyzer 100.

A molecular sieve may be microporous with a tunnel-like pore structure of similar dimensions to small molecules. They may include inorganic materials that possess uniform pores with diameters in the micro-, meso-, or macrosize range. Retention may be primarily controlled by molecular size, whether the analyte can enter the pore structure of the molecular sieve, and by the strength of adsorption interactions with the internal pore surface.

Molecular sieves are extremely efficient desiccants and they provide a very low residual vapor pressure.

Specific, uniform pore size is advantageous to adsorbent efficiency and selectivity. Based on size and charge distribution in a molecule, zeolite molecular sieves, by way of example and not limitation, can adsorb individual molecules readily, slowly or not at all. Molecular sieves are high capacity, selective adsorbents capable of separating molecules based on the size and shape of the molecule relative to the size and geometry of the main apertures of the structures. They adsorb molecules with a selectivity that is not found in other solid adsorbents.

The crystal structure of zeolite molecular sieves is honeycombed with relatively large cavities. Each cavity is connected through apertures or pores. The water of hydration is contained within these cavities. Before product is used, the water of hydration is removed by heating.

The molecular sieve may include particles such as powders, pellets, beads, fragments, or the like or combination thereof. The particles may include intercrystalline macropores and microporous crystals with intracrystalline micropores.

A plurality of particles may be disposed in a suitable sieve housing (e.g., a sieve housing) such that the particles can adsorb or absorb one or more gasses that are diffusing within the analyzer. The sieve housing may include openings, perforations, or is otherwise porous relative to the gasses to be adsorbed. Thus, the housing can contain the particles while allowing the diffused gasses to be adsorbed. In a particular embodiments of the purger or of the molecular sieve, the particles may all be of the same type and/or size and/or shape. Thus, pellets may be used in one molecular sieve while beads may be used in another molecular sieve. The sieve housing may be perforated such that air or other gasses can enter into the sieve housing and interact with the particles. The perforations are typically sized such that the particles (powder, pellets, beads, etc.) do not fall out of the sieve housing. The particles may also be enclosed within a cloth or other porous material or fluid.

As a result, the sieve housing shape can be altered based on the geometry or configuration of the analyzer, and or the adsorbing material. The sieve housing may be cylindrical, rectangular, cubic, or the like. The sieve housing may have a height that is larger than its' width (e.g., a long thin tube shape). Further, an interior of the sieve housing may be divided into sections and each section may contain a different purger (e.g, a different type and/or shape of zeolite or other adsorber or other crystalline substance). Alternatively, different types and/or shapes of gas adsorbing or absorbing material may be mixed within the same section or within the same sieve housing. The housing may include a mount that may allow the sieve housing to be detachably mounted to the interior of the analyzer's housing (or portion thereof such as a panel or cap). The gas analyzer's housing may include a mounting configured to connect to the mounting of the molecular sieve's housing. The sieve housing may be configured to be opened such that the adsorbent material can be replaced without replacing the sieve housing. For example, a sieve housing shaped as a cylinder may have one end that is configured to be removably attached (e.g., screwed on and screwed off).

For example, the interior housing (or plug or cap inserted into the housing) of the analyzer may include brackets. The sieve housing may include flanges that can slide into the brackets. The housing may be strapped into place inside the analyzer. In one example, the analyzer may be configured with a circulator (e.g, a device) that aids in circulating any gasses inside the analyzer.

In example, the interior portions of the housing 116 may be connected with the interior portions of the housing 108, the housing 106 and the housing 104. In one example, the interior space of the analyzer is not necessarily compartmentalized. As a result, all gasses absorbed or adsorbed inside any portion of the analyzer 100 can be absorbed or adsorbed by the purger 120.

In one example, the purger 120 purges the interior of the housing over time as the gasses diffuse within the interior. As a result, the process may require time to be fully or sufficiently purged. There is no need to use the purger 120 in conjunction with a forced flow of gas with respect to the purger 120. Rather, diffusion and time are needed to sufficiently purge the interior of analyzer 100.

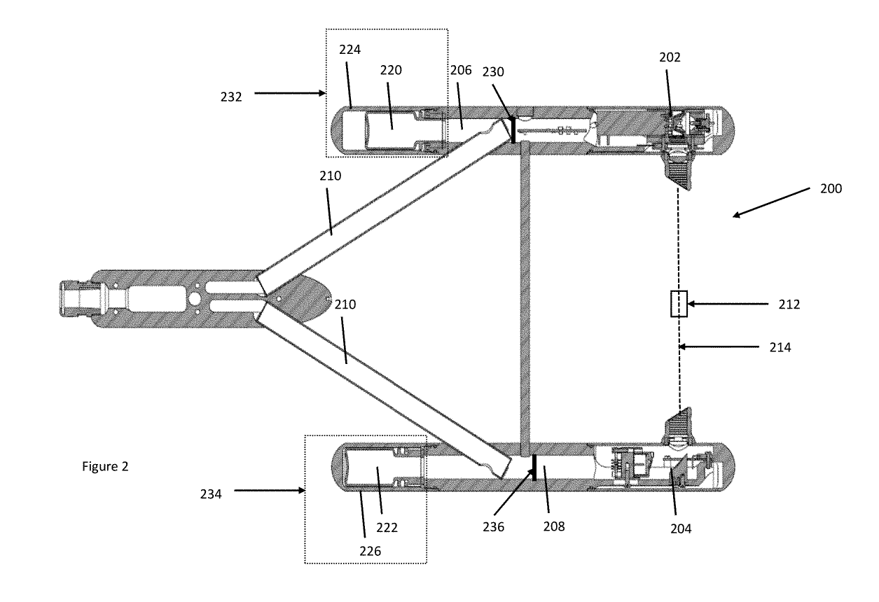

FIG. 2 illustrates a cross sectional view 200 of the analyzer 100. FIG. 2 illustrates that the interior includes optical components 202 and 204. The interior includes opens space, represented by elements 206, 210, and 208. The open air path 214 samples air 212 in the path between the optical components 202 and 204. The openness of the interior thus uses a purger 220 and/or 222 to purge the interior of the analyzer shown in FIG. 2.

FIG. 2 illustrates further that the end caps 224 and 226 (examples of housings) are removable such that the purgers 220 and 222 can be accessed and replaced as necessary. The purgers 220 and 222 can be located at other locations.

In one example, the purgers could be implemented or placed on an interior wall of the housing. The purgers can be shaped to conform to the interior walls and can be placed at multiple locations. In another example, the purgers can be mounted as a wall that effectively separates one interior space from another interior space. This may allow the size of the analyzer to be reduced.

In one example, the portions 232 and 234 could be removed from the analyzer 200. The purger 230 could be placed closer to the optical component 202 and may disposed on an interior wall. Optionally, another purger 236 could be placed or mounted on the interior wall in the other side of the analyzer 200. The purgers 230 and 236 may be formed as a wall such that the gasses diffuse through the purgers 230 and 236 over time. In addition, an access port may be formed in the housing to allow access to the purgers 230 and/or 236. A purger could be placed at other locations inside the housing of the analyzer as well.

Any of the purgers may be shaped as a flat disk whose perimeter is shaped to an interior surface of the analyzer housing. In one example, the purger may interface with the interior wall via a seal or may fit in a groove or the like.

The purger may be embodied as a cartridge that can be inserted/removed from the analyzer. The purger may be associated with a cartridge holder. The cartridge holder (or other holder) may be an integral part of the housing (e.g., molded) or may be attached to the housing. The holder may be part of a panel, part of a cap or the like. When inserted, the purger is positioned to absorb or adsorb gasses from the interior. The purger can be replaced by extracting the old purger and inserting a new purger. In one example, the purger may only need to be placed inside the housing of the analyzer. Placing the purger inside the analyzer allows the diffused gasses to be absorbed or adsorbed.

Embodiments of the invention thus relate to a gas analyzer that may use a purger such as a molecular sieve to purge the interior of the gas analyzer of certain gasses. The purger can be integrated or placed on interior walls or in positions that do not inhibit the diffusion rate of the gasses inside the housing of the gas analyzer. Further, the housing sections are components of the gas analyzer are arranged to ensure that blind holes or small or narrow passages are avoided. The interior of the analyzer is configured such that the impact of the interior space impacts the diffusion rate as little as possible. In other words, the interior of the analyzer is configured to facilitate the diffusion of gasses—holes and small or narrow passages may be eliminated or minimized from the configuration of the analyzer's interior. This prevents gasses from accumulating in holes and small spaces (or otherwise impacting the diffusion rate) and ensures that the analyzer and purger operate as intended. The purger may be connected to a controller such that the controller can determine a time for replacement of the purger.

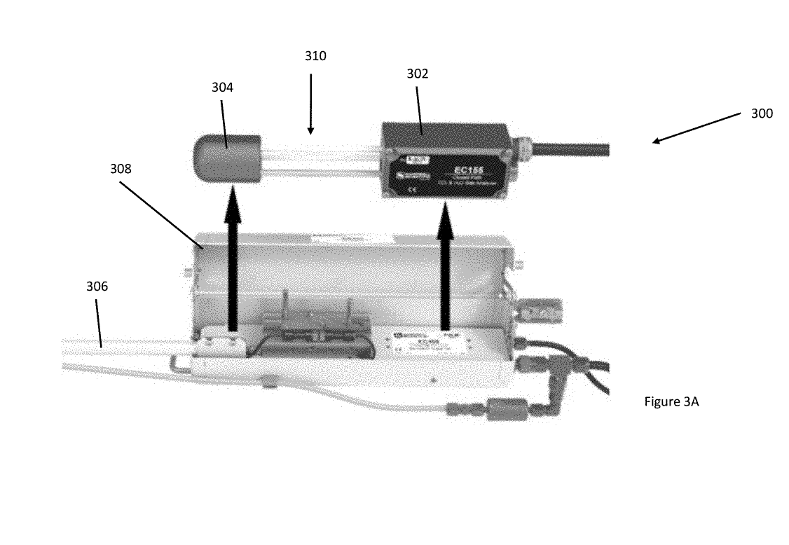

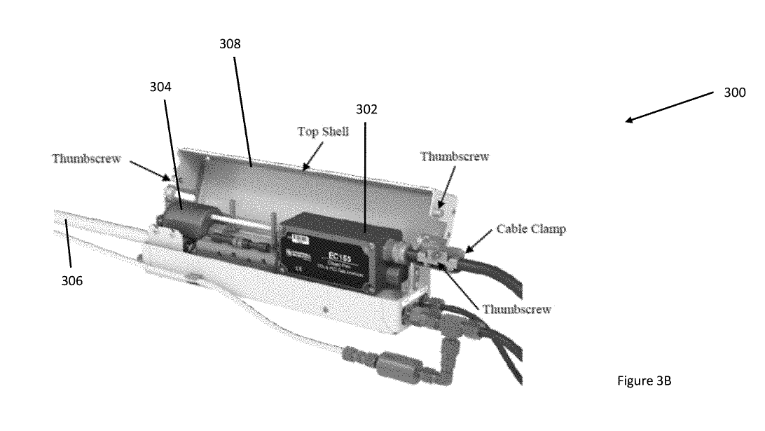

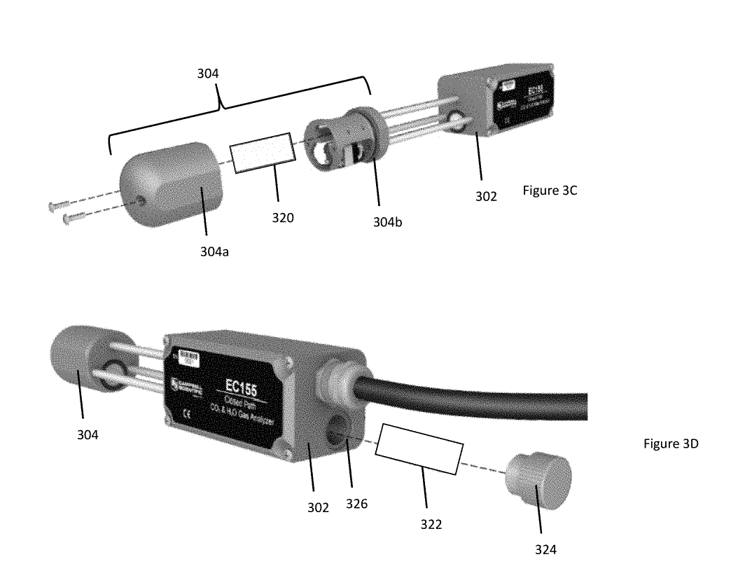

FIG. 3 (FIGS. 3A-3D) illustrates an example of a closed path analyzer 300. FIG. 3A illustrates a closed path analyzer 300 that is configured to reside inside a casing 308. FIG. 3 A illustrates that the analyzer 300 can be removed from the casing 308.

An intake 306 is provided such that an air sample can be drawn into the casing 308. The sample drawn into the analyzer 300 is thus positioned between the component 302 and the component 304. The analyzer 300 can thus use an optical signal that passes between the component 302 and the component 304 and through the air sample. For example, optical components may reside in the component 304 and optical components and processing components may reside in the component 302. The conduit 310 may be used for wiring and to separate the components 302 and 304 to provide for an air path.

In this example, the interior of the component 304 may not be connected to the interior of the housing 302. As a result, a purger may be required to be placed inside of each of the components 302 and 304.

FIG. 3B illustrates the analyzer 300 placed into the casing 308. FIG. 3C illustrates that the component 304 includes a cover 304a and a body 304b. Optical components and other circuitry are disposed in the body 304b. The cover 304a is removable such that the purger 320 can be inserted, replaced, etc. In this example, an O ring may be used to form a seal between the cover 304a and the body 304b. This arrangement allows the purger 320 to purge the interior of the component 304.

FIG. 3D illustrates that the component 302 includes an access portion 326 in which a purger 322 may be disposed or positioned. A cap 324 can be used to seal the access portion 326. Thus, the purger 322 is in communication with the interior of the component 302 such that gasses like CO₂ and H₂O can be purged or adsorbed or absorbed by the purger 322. As previously stated, the purger 322 (and 320) may be a molecular sieve and the interiors of the components 302 and 304 may be purged over time as the gasses diffuse within the interiors.

In one example, the cap 324 may comprise a holder configured to removably hold the purger 322. The cap 324 may include a slot that removably connects with one end of the purger 322. The other end of the purger is thus held or extended into the interior of the analyzer. The purger 322 (in particular, the molecular sieve) may be held away from interior walls such that the gasses can be adsorbed from multiple directions and such that a surface of the molecular sieve or purger through which the gasses enter is exposed.

The cap 324 or other portion of the analyzer may comprise arms arranged to securely hold the purger 322 in place. The arms may hold the purger by friction for example. A user may be able to extract or remove the purger from the arms by pulling on the purger. The arms may include a flange that interact with indentations on the purger's housing such that the purger snaps into place during insertion when the flanges engage the indentations. In this case, the arms may have flexibility that allow the flange to be removed from the indentations during removal of the purger.

The purgers discussed herein can be sized according to the interior volume of the analyzers. The purger may be configured to rest or be placed in the interior volume of the analyzer. The analyzer may be configured with a holder configured to hold the purger in place. This may include an elastic fitting that holds the purger by friction or elastic force. The purger may include threads or other engagement mechanisms that engage with corresponding mechanisms in the analyzer or portion thereof. The purger may be static and unconnected electrically. The analyzer may be configured to accommodate multiple purgers at the same time. Each of the purgers may be configured to absorb or adsorb certain gasses. The purger may be held, once installed, such that the purger is held in place regardless of how the analyzer is oriented.

The purger may be associated with a sensor adapted to measure gasses inside the interior of the analyzer. This may allow the level of the gasses to be tracked over time or at selected times. This may allow the expected diffusion rate to be compared with a measured diffusion rate. Alternatively, the sensor may determine whether the analyzer can be operated such that the measurements are not affected by gasses in the interior of the gas analyzer. Alternatively, the analyzer may wait for a predetermined period of time prior to taking measurements to ensure that the gasses have sufficiently diffused and to ensure that the gasses have been absorbed or adsorbed by the purger.

In one example, a method of operation may include inserting a purger into the interior of the housing. This may include removing a housing portion (e.g., a cap, a lid, a base, or other removable portion). The housing portion (e.g., the cover 304a or cap 324) may have be associated with a seal such that, when attached or connected, an interface between the housing portion and a main body of the analyzer is sealed.

A purger is then inserted into the interior of the housing. For example, a holder or carriage may be formed in the cap or cover or in the main body. The purger can be placed in the holder and the housing portion can then be replaced such that the purger is sealed inside the housing. Operation of the analyzer may not be performed until a certain period of time has passed. This allows the purger to absorb or adsorb any gasses that may be introduced when replacing the purger.

When a sensor is placed inside the housing, operation of the purger can be controlled based on readings of the sensor. The sensor may measure internal gas concentrations. When the concentrations are below a threshold (due to absorption by the purger), operation may be enabled. The sensor may be integrated into the purger. The sensor may or may not be connectable to a processor or controller. If configured, the sensor may generate and/or store data than can be read by the processor (e.g., time of operation, start date, configuration, size, life expectancy, or other characteristics). This allows the processor to estimate the remaining life of the purger, notify a user of the need to replace the purger or estimated purger life remaining, detect abnormalities or malfunctions, or the like.

The embodiments described herein may include the use of a special purpose or general-purpose computer including various computer hardware or software modules which may be used in association with a processor or datalogger in order to analyze the data collected from the gas analyzer described herein.

Although these components are described generally herein, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A gas analyzer comprising:
a housing that includes a main body and a housing portion;
a purger disposed in an interior of the housing, wherein the purger includes a molecular sieve;
a sensing system configured to measure quantities of different gasses included in an air sample, wherein the purger is configured to adsorb gasses such that operation of the sensing system is not affected by the gasses in the interior of the housing.

2. The has analyzer of claim 1, wherein the purger comprises a cartridge.

3. The gas analyzer of claim 2, wherein the cartridge is removably inserted into the interior of the housing and wherein the cartridge is replaceable.

4. The gas analyzer of claim 3, wherein the purger comprises a molecular sieve, wherein the molecular sieve is integrated with the cartridge.

5. The gas analyzer of claim 1, wherein the housing portion is removable from the main body and wherein the purger is accessed by removing the housing portion from the main body.

6. The gas analyzer of claim 5, wherein the housing portion comprises a seal to seal an interface between the main body and the housing portion.

7. The gas analyzer of claim 6, wherein the housing portion is configured to removably hold the purger.

8. The gas analyzer of claim 6, wherein the main body includes a first portion and a second portion whose interiors are not connected, the purger comprising a first purger adapted to be accommodated in an interior of the first portion and a second purger adapted to be accommodated in an interior of the second portion.

9. The gas analyzer of claim 1, wherein the purger is configured such that a diffusion rate is not affected.

10. The gas analyzer of claim 1, wherein the interior is arranged such that a rate of diffusion is not adversely affected.

11. The gas analyzer of claim 1, wherein the gas analyzer comprises a sensor that operates to determine when the interior is sufficiently purged by the purger.

12. The gas analyzer of claim 1, further comprising a controller that is configured to control when measurements are performed based on a diffusion rate and based on how long the purger has been inside the housing.

13. The gas analyzer of claim 5, wherein the housing portion comprises a cap or a panel.
The gas analyzer of claim 5, wherein the housing portion comprises arms configured to removably hold the purger, wherein the purger is held such that a portion of the purger through which gasses enter the purger are not in contact with an interior wall of the gas analyzer.

14. The gas analyzer of claim 1, wherein the molecular sieve comprises zeolite and is formed as powder, pellets or beads, wherein the powder pellets or beads are contained in a sieve housing that is perforated.
